(19) United States
(12) Patent Application Publication
(10) Pub. No.: US 2014/0075379 A1
(43) Pub. Date: Mar. 13, 2014

(54) DIRECT CHARACTER DISPLAY CONTROL

(71) Applicants: Erich Schlaepfer, Sunnyvale, CA (US); Chris Jones, San Francisco, CA (US)

(72) Inventors: Erich Schlaepfer, Sunnyvale, CA (US); Chris Jones, San Francisco, CA (US)

(21) Appl. No.: 13/609,586

(22) Filed: Sep. 11, 2012

(51) Int. Cl. G06F 3/041; G06F 3/048

(52) U.S. Cl. 715/810

(57) ABSTRACT

A display device may be, operable to display one or more characters. Each of the characters may comprise an upper portion and a lower portion. The display device may detect a touch from a user on one of two areas associated with a character. A first area of the two areas may be associated with the upper portion of the character and a second area of the two areas may be associated with the lower portion of the character. The display device may change the character based on the detected touch on the one of the two areas. When the touch is detected on the first area associated with the upper portion of a digit, the display device may increase the digit by one. When the touch is detected on the second area associated with the lower portion of the digit, the display device may decrease the digit by one.

### FIELD

Certain embodiments of the disclosure relate to character displays. More specifically, certain embodiments of the disclosure relate to a method and system for direct character display control.

### BACKGROUND

A display device may display characters such as digits (digital numbers) and/or letters. A display device may be, for example, an electronic clock, a mobile phone, a smart phone, a tablet or other type of similar device. Digital displays, such as those used by electronic clock devices, often use indirect methods for modifying display data. For example, an alarm clock device may use a single button to cycle through hours and another button to cycle through minutes. Another example is the use of a knob control to update the displayed digits. In such an instance, however, the control may still be very slow.

Further limitations and disadvantages of conventional and traditional approaches will become apparent to one of skill in the art, through comparison of such systems with the present disclosure as set forth in the remainder of the present application with reference to the drawings.

### BRIEF SUMMARY OF THE DISCLOSURE

Aspects of the present disclosure are directed to a method and system for direct character display control. In various embodiments of the disclosure, a display device may be operable to display one or more characters. The one or more characters may comprise one or more digits and/or one or more letters. The display device may comprise, for example, an electronic clock, a mobile phone, a smart phone, a tablet and/or other similar type of device. Each of the characters may comprise an upper portion and a lower portion. The display device may detect a touch from a user on one of two areas associated with a character among the displayed one or more characters. In this regard, a first area of the two areas may be associated with the upper portion of the character, and a second area of the two areas may be associated with the lower portion of the character. The display device may change the character based on the detected touch on the one of the two areas associated with the character.

Various advantages, aspects and novel features of the present disclosure, as well as details of an illustrated embodiment thereof, will be more fully understood from the following description and drawings.

### BRIEF DESCRIPTION OF DRAWINGS

FIG. 1 is a block diagram illustrating an example display device displaying characters, in accordance with an embodiment of the disclosure.

FIG. 2 is a block diagram illustrating an example display device comprising direct character display control, in accordance with an embodiment of the disclosure.

FIG. 3 is a block diagram illustrating an example scenario of increasing a digit, in accordance with an embodiment of the disclosure.

FIG. 4 is a block diagram illustrating an example scenario of decreasing a digit, in accordance with an embodiment of the disclosure.

FIG. 5 is a block diagram illustrating an example scenario of incrementing a letter, in accordance with an embodiment of the disclosure.

FIG. 6 is a block diagram illustrating an example scenario of decrementing a letter, in accordance with an embodiment of the disclosure.

FIG. 7 is a flow chart illustrating example steps for direct character display control, in accordance with an embodiment of the disclosure.

FIG. 8 is a flow chart illustrating example steps for direct digit display control, in accordance with an embodiment of the disclosure.

FIG. 9 is a flow chart illustrating example steps for direct digit display control for seven-segment display, in accordance with an embodiment of the disclosure.

FIG. 10 is a flow chart illustrating example steps for direct letter display control, in accordance with an embodiment of the disclosure.

### DETAILED DESCRIPTION

Certain embodiments of the disclosure can be found in a method and system for direct character display control. Certain specific details are set forth in the following description and in drawings to provide a thorough understanding of various embodiments of the disclosure. One skilled in the art, however, will understand that additional embodiments of the present disclosure may be practiced without several of the details described in the following description.

In various embodiments of the disclosure, a display device may be operable to display one or more characters, where each of the one or more characters may comprise an upper portion and a lower portion. The display device may be operable to detect a touch from a user on one of two areas associated with a character among the displayed one or more characters. In this regard, a first area of the two areas may be associated with the upper portion of the character, and a second area of the two areas may be associated with the lower portion of the character. The display device may be operable to change the character based on the detected touch on the one of the two areas associated with the character.

In an example embodiment of the disclosure, the one or more characters may comprise one or more digits. In instances when the touch is detected on the first area associated with the upper portion of a digit, the display device may be operable to increase the digit by one. In instances when the touch is detected on the second area associated with the lower portion of the digit, the display device may be operable to decrease the digit by one. In some instances, each of the one or more digits may comprise seven segments, where the seven segments may comprise three upper segments, three lower segments and one middle segment. In this regard, the upper portion may correspond to the three upper segments of the digit and the lower portion may correspond to the three lower segments of the digit.

In an example embodiment of the disclosure, the one or more characters may comprise one or more letters. In instances when the touch is detected on the first area associated with the upper portion of a letter, the display device may be operable to increment the letter by one letter. In instances when the touch is detected on the second area associated with the lower portion of the letter, the display device may be operable to decrement the letter by one letter.

The display device may be operable to detect the touch utilizing a capacitive sensing, for example. In such an instance, the one of the two areas may be touched by a finger of the user, for example. The display device may be operable to detect the touch utilizing touchscreen sensing, for example. In such an instance, the one of the two areas may be touched by a finger of the user and/or by a stylus, for example. The display device may also be operable to detect the touch via a mechanical button on each of the two areas, for example.

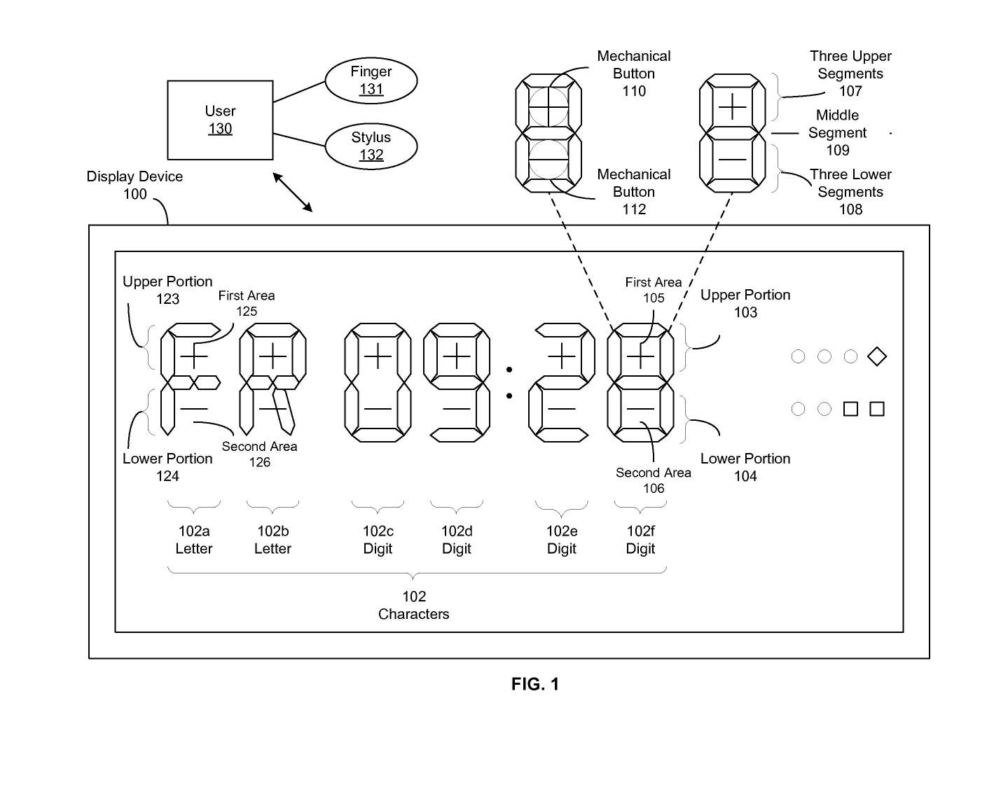

FIG. 1 is a block diagram illustrating an example display device displaying characters, in accordance with an embodiment of the disclosure. Referring to FIG. 1, there is shown a display device 100. The display device 100 may display a plurality of characters 120, of which letters 102a-102b and digits 102c-102f are illustrated. The display device 100 may comprise, for example, an electronic clock, a mobile phone, a smart phone, a tablet and/or other similar type of display device.

In operation, the display device 100 may be operable to display one or more characters 102a-102f, where each of the one or more characters 102a-102f may comprise an upper portion, such as the upper portion 103, and a lower portion, such as the lower portion 104. The display device 100 may be operable to detect a touch from a user 130 on one of two areas associated with a character such as the digit 102f among the displayed one or more characters 102a-102f. In this regard, a first area such as the first area 105 of the two areas may be associated with the upper portion 103 of the character 102f, and a second area such as the second area 106 of the two areas may be associated with the lower portion 104 of the character 102f. The display device 100 may be operable to change the character 102f based on the detected touch on the one of the two areas 105, 106 associated with the character 102f.

In an example embodiment of the disclosure, the one or more characters 120 may comprise one or more digits such as the digits 102c-102f. In instances when the touch is detected on the first area 105 associated with the upper portion 103 of the digit 102f, the display device 100 may be operable to increase the digit 102f by one. In instances when the touch is detected on the second area 106 associated with the lower portion 104 of the digit 102f, the display device 100 may be operable to decrease the digit 102f by one.

In an example embodiment of the disclosure, each of the one or more digits 102c-102f may comprise seven segments, where the seven segments may comprise three upper segments such as the three upper segments 107, three lower segments such as the three lower segments 108, and one middle segment such as the middle segment 109. In this regard, the upper portion 103 may correspond to the three upper segments 107 of the digit 102f and the lower portion 104 may correspond to the three lower segments 108 of the digit 102f.

In an example embodiment of the disclosure, the one or more characters 120 may comprise one or more letters such as the letters 102a-102b. In instances when the touch is detected on a first area such as the first area 125 associated with an upper portion such as the, upper portion 123 of a letter such as the letter 102a, the display device 100 may be operable to increment the letter 102a by one letter. In instances when the touch is detected on a second area such as the second area 126 associated with a lower portion such as the lower portion 124 of a letter such as the letter 102a, the display device 100 may be operable to decrement the letter 102a by one letter.

The display device 100 may be operable to detect the touch, for example, utilizing a capacitive sensing. A capacitive sensor may detect anything that is conductive or has a dielectric different than that of air. In such an instance, the one of the two areas 105, 106 (or 125, 126) may be touched by a finger 131 of the user 130, for example. The display device 100 may also be operable to detect the touch, for example, utilizing touchscreen sensing. A touchscreen display may detect a presence and a location of a touch within a display area. In such an instance, the one of the two areas 105, 106 (or 125, 126) may be touched by a finger 131 of the user 130 and/or by a stylus 132, for example. The display device 100 may also be operable to detect the touch via a mechanical button on each of the two areas 105, 106 (or 125, 126). For example, a mechanical button 110 may be on the first area 105 and a mechanical button 112 may be on the second area 106.

In the example embodiment of the disclosure illustrated in FIG.1, a first area 105 is shown within an upper portion 103 of a character 102f and a second area 106 is shown within a lower portion 104 of a character 102f. Notwithstanding, the two areas 105, 106 may not be so limited. For example, the first area 105 located outside (e.g., above) the upper portion 103 of the character 102f and/or the second area 106 located outside (e.g., below) the lower portion 104 of the character 102f may be illustrated without departing from the spirit and scope of various embodiments of the disclosure.

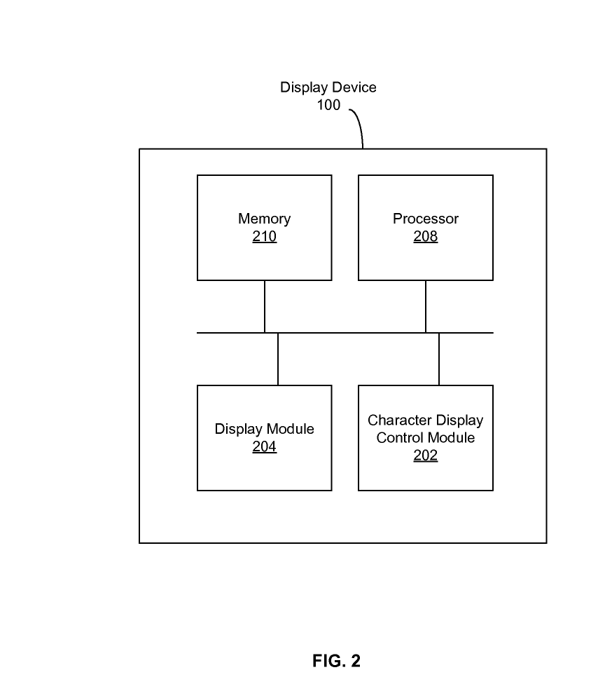

FIG. 2 is a block diagram illustrating an example display device comprising direct character display control, in accordance with an embodiment of the disclosure. Referring to FIG. 2, there is shown the display device 100. The display device 100 may comprise a display module 204, a processor 208, a memory 210 and a character display control module 202. The display device 100 may be as described with respect to FIG. 1, for example.

The display module 204 may comprise suitable logic, circuitry, interfaces and/or code that may be operable to display or present processed content to a user such as the user 130 of the display device 100. In an example embodiment of the disclosure, the display module 204 may be operable to display one or more characters such as the characters 102a-102f.

The processor 208 may comprise suitable logic, circuitry, interfaces and/or code that may be operable to process signals or data. The processor 208 may be operable to manage and/or control operations of various modules or components in the display device 100.

The memory 210 may comprise suitable logic, circuitry, interfaces and/or code that may be operable to store information such as executable instructions and data that may be utilized by the processor 208, the display module 204 and/or the character display control module 202. The memory 210 may comprise RAM, ROM, low latency nonvolatile memory such as flash memory and/or other suitable electronic data storage.

The character display control module 202 may comprise suitable logic, circuitry, interfaces and/or code that may be operable to provide character display control functions for the display device 100. In an example embodiment of the disclosure, the character display control module 202 may be operable to detect a touch, for example, from a user 130 on one of two areas associated with a character such as the character 102f. The character display control module 202 may be operable to change the character 102f based on the detected touch on the one of the two areas 105, 106 associated with the character 102f.

In operation, the display module 204 may be operable to display one or more characters 102a-102f, where each of the one or more characters 102a-102f may comprise an upper portion, such as the upper portion 103, and a lower portion, such as the lower portion 104. The character display control module 202 may be operable to detect a touch from a user 130 on one of two areas such as the two areas 105, 106 associated with a character such as the character 102f. The character display control module 202 may be operable to change the character 102f based on the detected touch on the one of the two areas 105, 106 associated with the character 102f. For example, in instances when the touch is detected on the first area 105 associated with the upper portion 103 of the digit 102f, the character display control module 202 may be operable to increase the digit 102f by one. In instances when the touch is detected on the second area 106 associated with the lower portion 104 of the digit 102f, the character display control module 202 may be operable to decrease the digit 102f by one.

The character display control module 202 may be operable to detect the touch, for example, utilizing a capacitive sensing. In such an instance, the one of the two areas 105, 106 may be touched by a finger 131 of the user 130, for example. The character display control module 202 may also be operable to detect the touch, for example, utilizing touchscreen sensing. In such an instance, the one of the two areas 105, 106 may be touched by a finger 131 of the user 130 and/or by a stylus 132, for example. The character display control module 202 may also be operable to detect the touch via a mechanical button (e.g., the mechanical button 110 or the mechanical button 112) on each of the two areas 105, 106, for example.

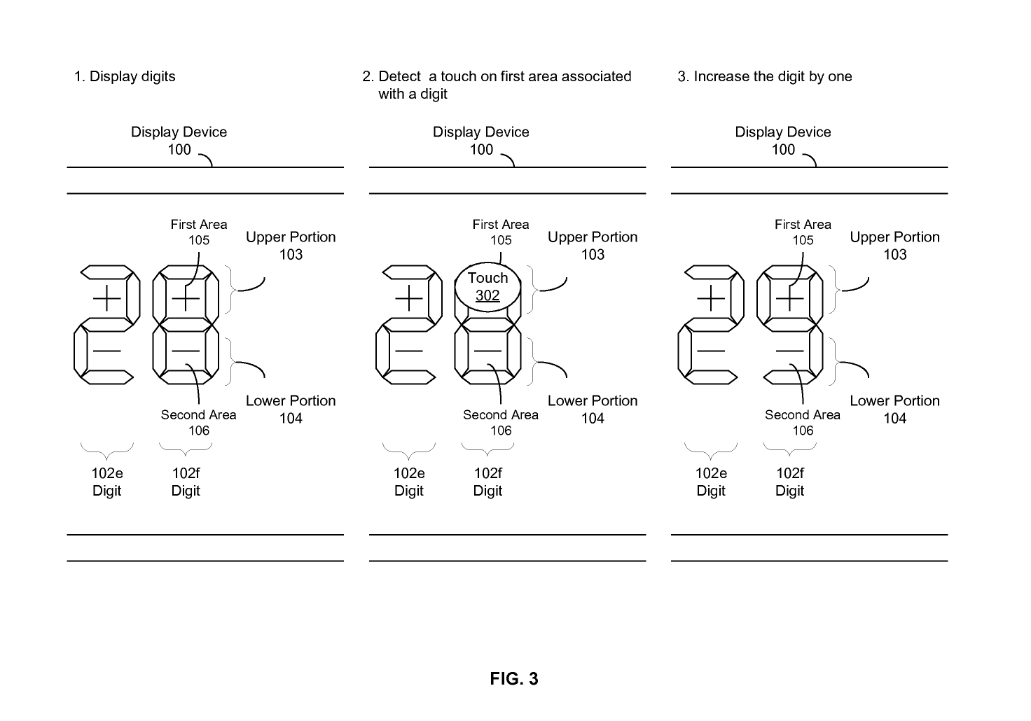

FIG. 3 is a block diagram illustrating an example scenario of increasing a digit, in accordance with an embodiment of the disclosure. Referring to FIG. 3, there is shown the display device 100 displaying digits, of which the digit 102e and the digit 102f are illustrated. The digit 102e may represent a decimal value 2 and the digit 102f may represent a decimal value 8, for example. The display device 100 may be as described with respect to FIG. 1, for example.

In an example operation, the display module 204 in the display device 100 may be operable to display at least the digits 102e, 102f. The character display control module 202 in the display device 100 may be operable to detect a touch 302 from a user, such as the user 130, on the first area 105 associated with the upper portion 103 of the digit 102f. Accordingly, the character display control module 202 may be operable to increase the digit 102f by one. In such an instance, the decimal value of the digit 102f may be changed from 8 to 9.

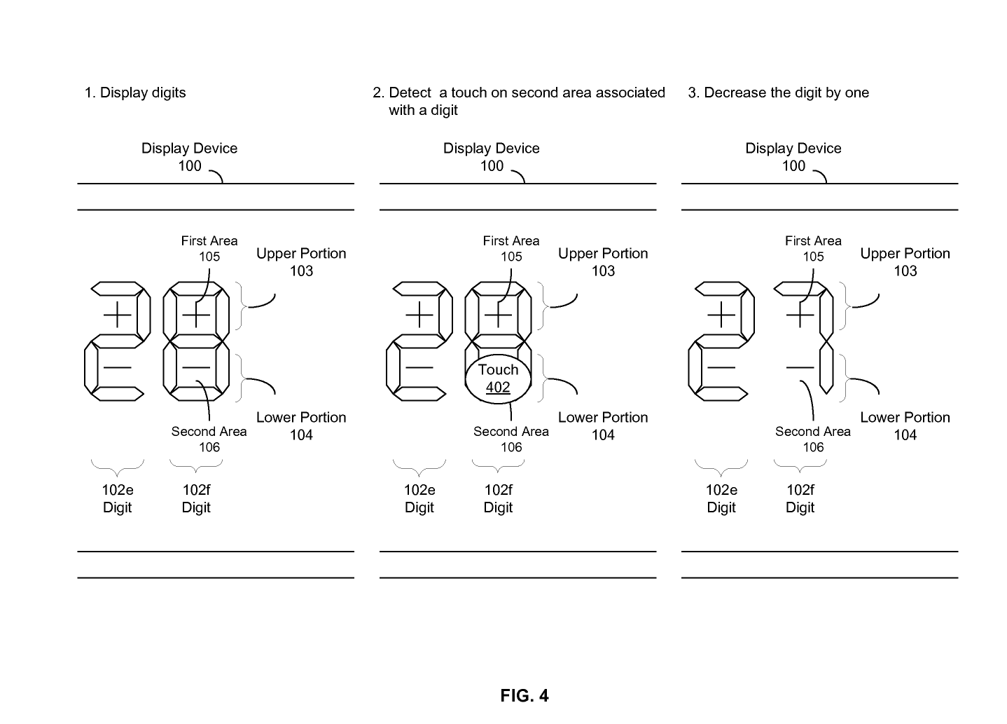

FIG. 4 is a block diagram illustrating an example scenario of decreasing a digit, in accordance with an embodiment of the disclosure. Referring to FIG. 4, there is shown the display device 100 displaying digits, of which the digit 102e and the digit 102f are illustrated. The digit 102e may represent a decimal value 2 and the digit 102f may represent a decimal value 8, for example. The display device 100 may be as described with respect to FIG. 1, for example.

In an example operation, the display module 204 in the display device 100 may be operable to display at least the digits 102e, 102f. The character display control module 202 in the display device 100 may be operable to detect a touch 402 from a user, such as the user 130, on the second area 106 associated with the lower portion 104 of the digit 102f. Accordingly, the character display control module 202 may be operable to decrease the digit 102f by one. In such an instance, the decimal value of the digit 102f may be changed from 8 to 7.

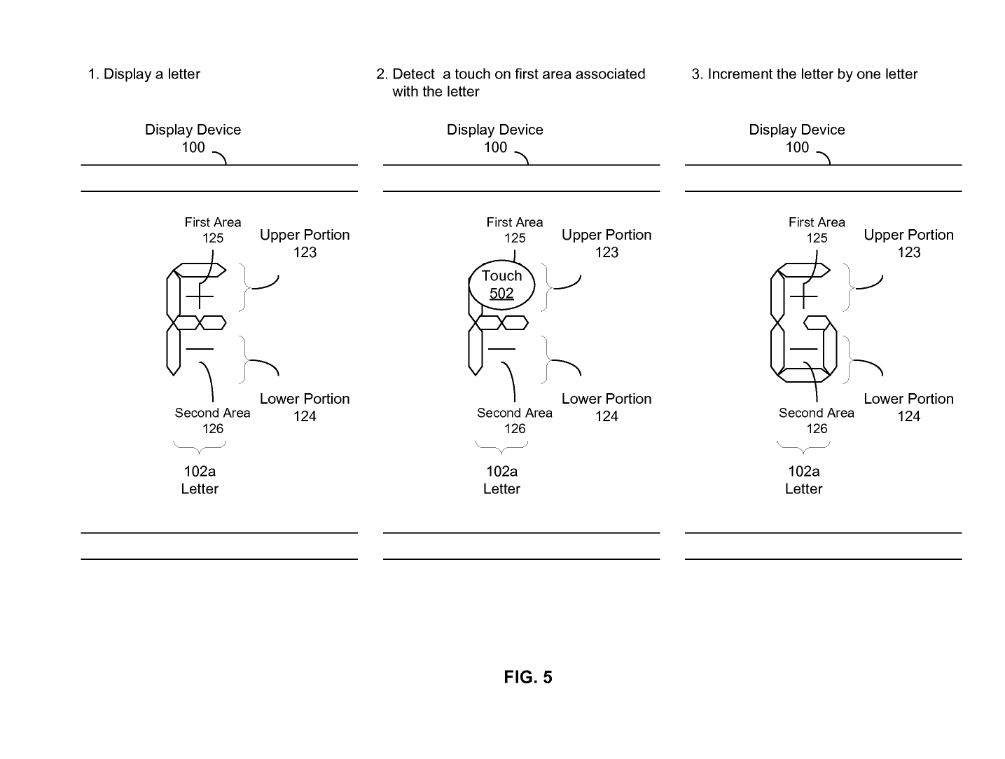

FIG. 5 is a block diagram illustrating an example scenario of incrementing a letter, in accordance with an embodiment of the disclosure. Referring to FIG. 5, there is shown the display device 100 displaying a letter, of which the letter 102a is illustrated. The letter 102a may be shown as the letter “F”, for example. The display device 100 may be as described with respect to FIG. 1, for example.

In an example operation, the display module 204 in the display device 100 may be operable to display at least the letter 102a. The character display control module 202 in the display device 100 may be operable to detect a touch 502 from a user, such as the user 130, on the first area 125 associated with the upper portion 123 of the letter 102a. Accordingly, the character display control module 202 may be operable to increment the letter 102a by one letter. In such an instance, the letter 102a may be changed from “F” to “G”.

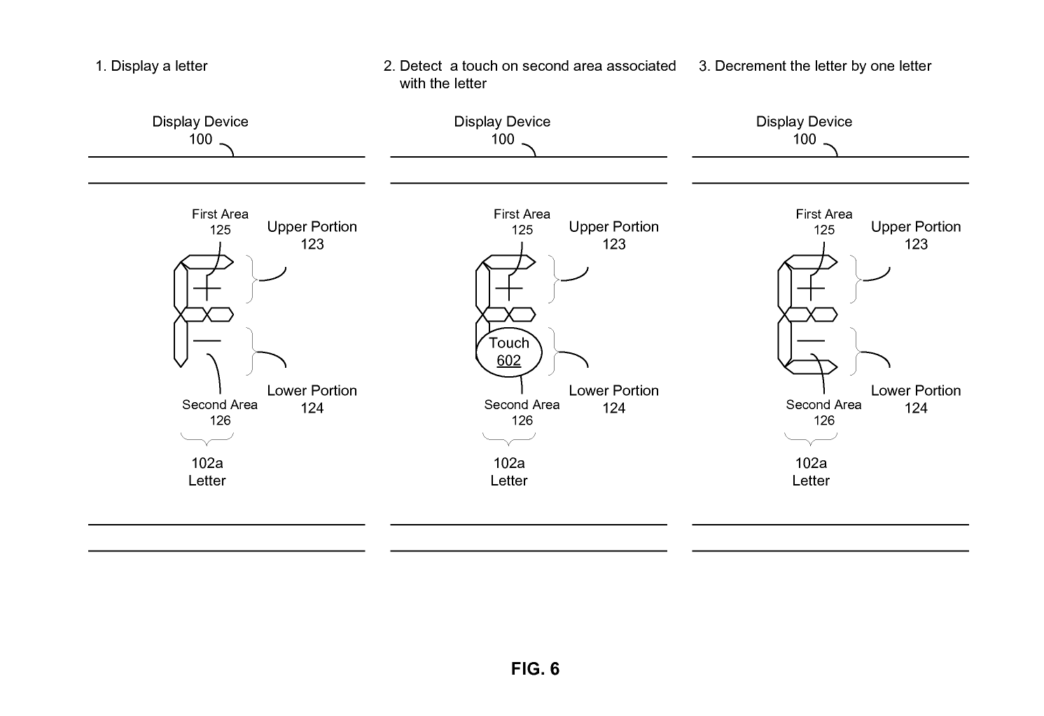

FIG. 6 is a block diagram illustrating an example scenario of decrementing a letter, in accordance with an embodiment of the disclosure. Referring to FIG. 6, there is shown the display device 100 displaying a letter, of which the letter 102a is illustrated. The letter 102a may be shown as the letter “F”, for example. The display device 100 may be as described with respect to FIG. 1, for example.

In an example operation, the display module 204 in the display device 100 may be operable to display at least the letter 102a. The character display control module 202 in the display device 100 may be operable to detect a touch 602 from a user, such as the user 130, on the second area 126 associated with the lower portion 124 of the letter 102a. Accordingly, the character display control module 202 may be operable to decrement the letter 102a by one letter. In such an instance, the letter 102a may be changed from “F” to “E”.

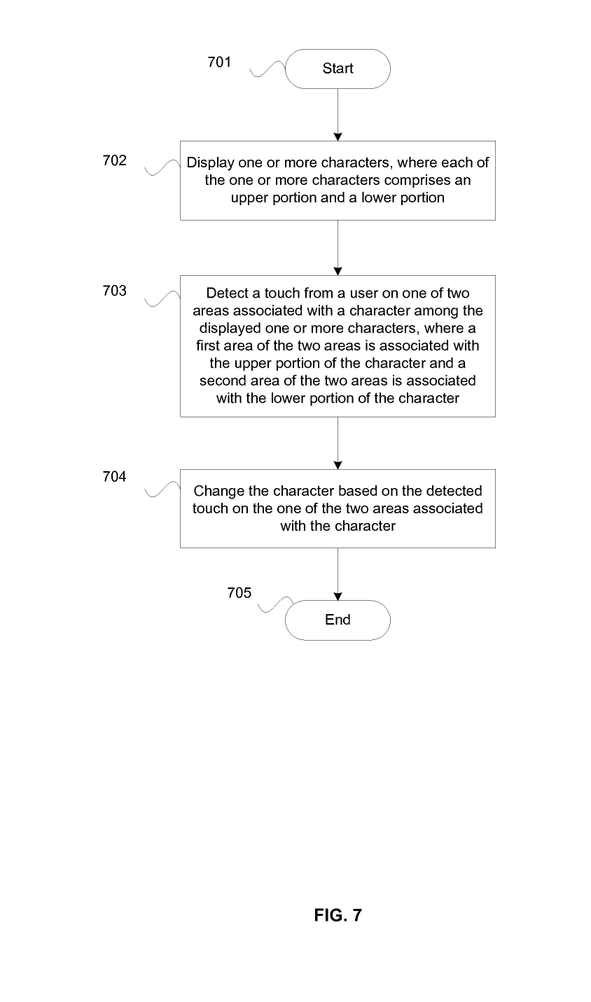

FIG. 7 is a flow chart illustrating example steps for direct character display control, in accordance with an embodiment of the disclosure. Referring to FIG. 7, the example steps start at step 701. In step 702, the display module 204 in the display device 100 may be operable to display one or more characters 102a-102f, where each of the one or more characters 102a-102f may comprise an upper portion, such as the upper portion 103, and a lower portion, such as the lower portion 104. In step 703, the character display control module 202 in the display device 100 may be operable to detect a touch from a user 130 on one of two areas associated with a character such as the character 102f among the displayed one or more characters 102a-102f. In this regard, a first area 105 of the two areas may be associated with the upper portion 103 of the character 102f and a second area 106 of the two areas may be associated with the lower portion 104 of the character 102f. In step 704, the character display control module 202 may be operable to change the character 102f based on the detected touch (e.g., the touch 302 or the touch 402) on the one of the two areas 105, 106 associated with the character 102f. The example steps may proceed to the end step 705.

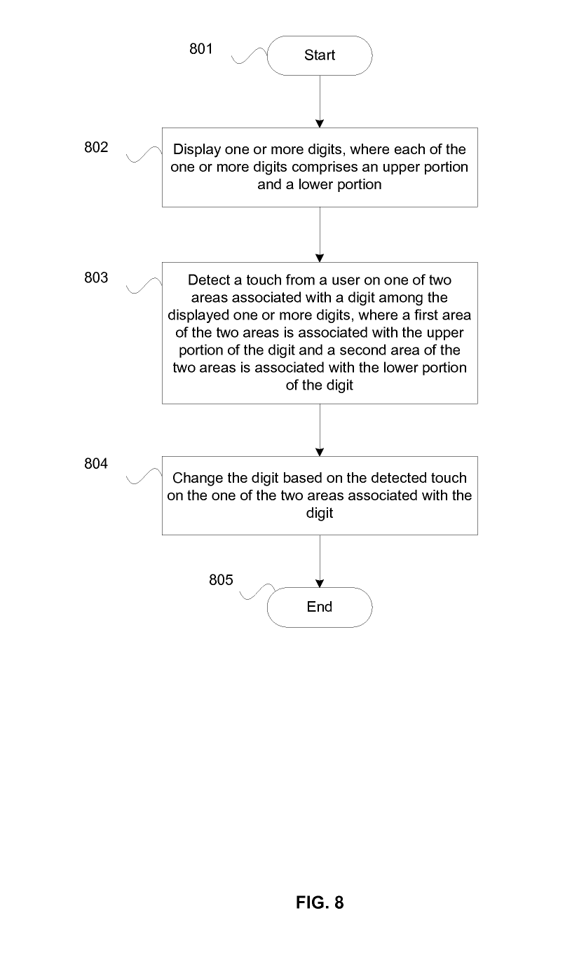

FIG. 8 is a flow chart illustrating example steps for direct digit display control, in accordance with an embodiment of the disclosure. Referring to FIG. 8, the example steps start at step 801. In step 802, the display module 204 in the display device 100 may be operable to display one or more digits 102c-102f, where each of the one or more digits 102c-102f may comprise an upper portion, such as the upper portion 103, and a lower portion, such as the lower portion 104. In step 803, the character display control module 202 in the display device 100 may be operable to detect a touch from a user 130 on one of two areas associated with a digit such as the digit 102f among the displayed one or more digits 102c-102f. In this regard, a first area 105 of the two areas may be associated with the upper portion 103 of the digit 102f and a second area 106 of the two areas may be associated with the lower portion 104 of the digit 102f. In step 804, the character display control module 202 may be operable to change the digit 102f based on the detected touch (e.g., the touch 302 or the touch 402) on the one of the two areas 105, 106 associated with the digit 102f. The example steps may proceed to the end step 805.

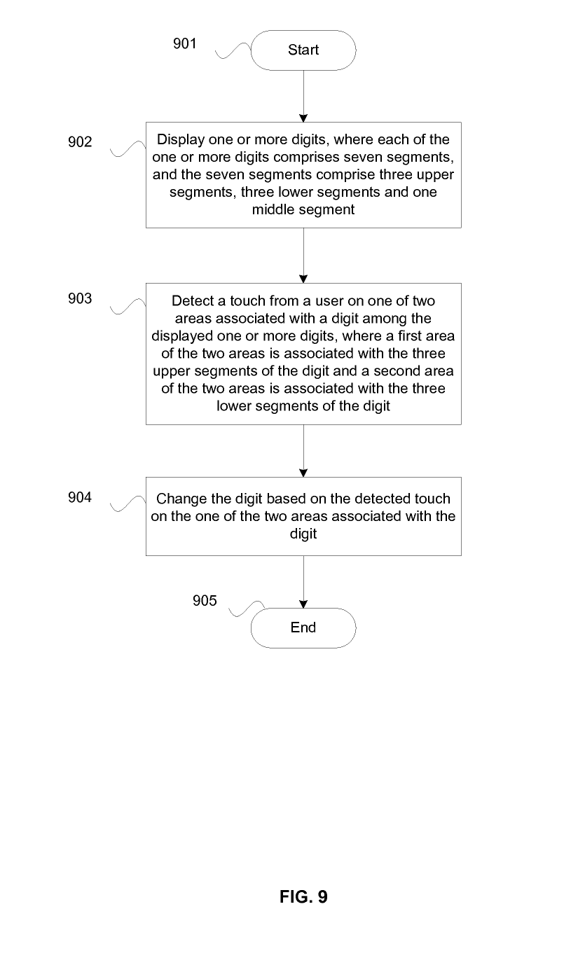

FIG. 9 is a flow chart illustrating example steps for direct digit display control for seven-segment display, in accordance with an embodiment of the disclosure. Referring to FIG.9, the example steps start at step 901. In step 902, the display module 204 in the display device 100 may be operable to display one or more digits 102c-102f, where each of the one or more digits 102c-102f may comprise seven segments, and the seven segments may comprise three upper segments 107, three lower segments 108 and one middle segment 109. In step 903, the character display control module 202 in the display device 100 may be operable to detect a touch from a user 130 on one of two areas associated with a digit such as the digit 102f among the displayed one or more digits 102c-102f. In this regard, a first area 105 of the two areas may be associated with the three upper segments 107 of the digit 102f and a second area 106 of the two areas may be associated with the three lower segments 108 of the digit 102f. In step 904, the character display control module 202 may be operable to change the digit 102f based on the detected touch (e.g., the touch 302 or the touch 402) on the one of the two areas 105, 106 associated with the digit 102f. The example steps may proceed to the end step 905.

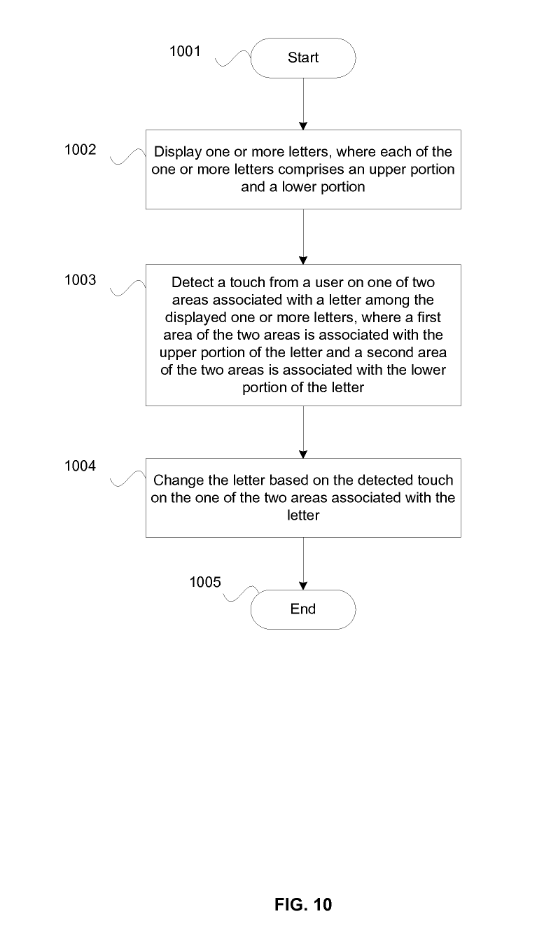

FIG. 10 is a flow chart illustrating example steps for direct letter display control, in accordance with an embodiment of the disclosure. Referring to FIG. 10, the example steps start at step 1001. In step 1002, the display module 204 in the display device 100 may be operable to display one or more letters 102a-102b, where each of the one or more letters 102a-102b may comprise an upper portion, such as the upper portion 123, and a lower portion, such as the lower portion 124. In step 1003, the character display control module 202 in the display device 100 may be operable to detect a touch from a user 130 on one of two areas associated with a letter such as the letter 102a among the displayed one or more letters 102a-102b. In this regard, a first area 125 of the two areas may be associated with the upper portion 123 of the letter 102a and a second area 126 of the two areas may be associated with the lower portion 124 of the letter 102a. In step 1004, the character display control module 202 may be operable to change the letter 102a based on the detected touch (e.g., the touch 502 or the touch 602) on the one of the two areas 125, 126 associated with the letter 102a. The example steps may proceed to the end step 1005.

In various embodiments of the disclosure, a display module such as the display module 204 in a display device 100 may be operable to display one or more characters 102a-102f, where each of the one or more characters 102a-102f may comprise an upper portion, such as the upper portion 103, and a lower portion, such as the lower portion 104. A character display control module such as the character display control module 202 in the display device 100 may be operable to detect a touch from a user 130 on one of two areas associated with a character such as the character 102f among the displayed one or more characters 102a-102f. In this regard, a first area such as the first area 105 of the two areas may be associated with the upper portion 103 of the character 102f, and a second area such as the second area 106 of the two areas may be associated with the lower portion 104 of the character 102f. The character display control module 202 may be operable to change the character 102f based on the detected touch (e.g., the touch 302 or the touch 402) on the one of the two areas 105, 106 associated with_{,} the character 102f. The display device 100 may comprise, for example, an electronic clock, a mobile phone, a smart phone, a tablet and/or other similar type of display device.

The one or more characters 120 may comprise, for example, one or more digits such as the digits 102c-102f. In instances when the touch such as the touch 302 is detected on the first area 105 associated with the upper portion 103 of the digit 102f, the character display control module 202 may be operable to increase the digit 102f by one. In instances when the touch such as the touch 402 is detected on the second area 106 associated with the lower portion 104 of the digit 102f, the character display control module 202 may be operable to decrease the digit 102f by one. In some instances, each of the one or more digits 102c-102f may comprise seven segments, where the seven segments may comprise three upper segments such as the three upper segments 107, three lower segments such as the three lower segments 108, and one middle segment such as the middle segment 109. In this regard, the upper portion 103 may correspond to the three upper segments 107 of the digit 102f and the lower portion 104 may correspond to the three lower segments 108 of the digit 102f.

The one or more characters 120 may also comprise, for example, one or more letters such as the letters 102a-102b. In instances when the touch such as the touch 502 is detected on a first area such as the first area 125 associated with an upper portion such as the upper portion 123 of a letter such as the letter 102a, the character display control module 202 may be operable to increment the letter 102a by one letter. In instances when the touch such as the touch 602 is detected on a second area such as the second area 126 associated with a lower portion such as the lower portion 124 of a letter such as the letter 102a, the character display control module 202 may be operable to decrement the letter 102a by one letter.

The character display control module 202 may be operable to detect the touch, for example, utilizing a capacitive sensing. In such an instance, the one of the two areas 105, 106 (or 125, 126) may be touched by a finger 131 of the user 130, for example. The character display control module 202 may also be operable to detect the touch, for example, utilizing touchscreen sensing. In such an instance, the one of the two areas 105, 106 (or 125, 126) may be touched by a finger 131 of the, user 130 and/or by a stylus 132, for example. The character display control module 202 may also be operable to detect the touch via a mechanical button (e.g., the mechanical button 110 or the mechanical button 112) on each of the two areas 105, 106 (or 125, 126), for example.

Other embodiments of the disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for direct character display control.

Accordingly, aspects of the present disclosure may be realized in hardware, software, or a combination of hardware and software. Aspects of the present disclosure may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

Aspects of the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method, comprising:
in a display device:
displaying one or more characters, wherein each of the one or more characters comprises an upper portion and a lower portion;
detecting a touch from a user on one of two areas associated with a character among the displayed one or more characters, wherein:
a first area of the two areas is associated with the upper portion of the character; and
a second area of the two areas is associated with the lower portion of the character; and
changing the character based on the detected touch on the one of the two areas associated with the character.

2. The method according to claim 1, wherein the one or more characters comprise one or more digits.

3. The method according to claim 2, comprising:
when the touch is detected on the first area associated with the upper portion of a digit, increasing the digit by one; and
when the touch is detected on the second area associated with the lower portion of the digit, decreasing the digit by one.

4. The method according to claim 2, wherein:
each of the one or more digits comprises seven segments;
the seven segments comprise three upper segments, three lower segments and one middle segment;
the upper portion corresponds to the three upper segments; and
the lower portion corresponds to the three lower segments.

5. The method according to claim 1, wherein the one or more characters comprise one or more letters.

6. The method according to claim 5, comprising:
when the touch is detected on the first area associated with the upper portion of a letter, incrementing the letter by one letter; and
when the touch is detected on the second area associated with the lower portion of the letter, decrementing the letter by one letter.

7. The method according to claim 1, comprising detecting the touch utilizing a capacitive sensing.

8. The method according to claim 7, wherein the one of the two areas is touched by a finger of the user.

9. The method according to claim 1, comprising detecting the touch utilizing touchscreen sensing.

10. The method according to claim 9, wherein the one of the two areas is touched by a finger of the user and/or by a stylus.

11. The method according to claim 1, comprising detecting the touch via a mechanical button on each of the two areas.

12. A system, comprising:
a display device, where the display device is operable to:
display one or more characters, wherein each of the one or more characters comprises an upper portion and a lower portion;
detect a touch from a user on one of two areas associated with a character among the displayed one or more characters, wherein:
a first area of the two areas is associated with the upper portion of the character; and
a second area of the two areas is associated with the lower portion of the character; and
change the character based on the detected touch on the one of the two areas associated with the character.

13. The system according to claim 12, wherein the one or more characters comprise one or more digits.

14. The system according to claim 13, wherein the display device is operable to:
when the touch is detected on the first area associated with the upper portion of a digit, increase the digit by one; and
when the touch is detected on the second area associated with the lower portion of the digit, decrease the digit by one.

15. The system according to claim 12, wherein the one or more characters comprise one or more letters.

16. The system according to claim 15, wherein the display device is operable to:
when the touch is detected on the first area associated with the upper portion of a letter, increment the letter by one letter; and
when the touch is detected on the second area associated with the lower portion of the letter, decrement the letter by one letter.

17. The system according to claim 12, wherein the display device is operable to detect the touch utilizing a capacitive sensing.

18. The system according to claim 12, wherein the display device is operable to detect the touch utilizing touchscreen sensing.

19. The system according to claim 12, wherein the display device is operable to detect the touch via a mechanical button on each of the two areas.

20. A method, comprising:
in a display device:
displaying one or more digits, wherein each of the one or more digits comprises an upper portion and a lower portion;
detecting a touch from a user on one of two areas associated with a digit among the displayed one or more digits, wherein:
a first area of the two areas is associated with the upper portion of the digit; and
a second area of the two areas is associated with the lower portion of the digit; and
changing the digit based on the detected touch on the one of the two areas associated with the digit.
